(19) United States
(12) Patent Application Publication
(10) Pub. No.: US 2007/0287774 A1
(43) Pub. Date: Dec. 13, 2007

(54) Rubber Composition Comprising a Polyhedral Oligomeric Silsesquioxane Additive

(75) Inventor: Gary S. Crutchley, Walsall (GB)

Correspondence Address: GREENLEE WINNER AND SULLIVAN P C, 4875 PEARL EAST CIRCLE, SUITE 200, BOULDER, CO, 80301, US

(73) Assignee: KUMHO EUROPEAN TECHNICAL CENTRE OPERATING IN EUROP, Birmingham (GB)

(21) Appl. No.: 11/575,022

(22) PCT Filed: Sep. 12, 2005
(86) PCT No.: PCT/GB05/03510

§ 371 Date: Jun. 21, 2007

(30) Foreign Application Priority Data
Sep. 11, 2004 (GB) 0420205.7
Nov. 23, 2004 (GB) 0425699.6

(51) Int. Cl. B60C 1/00; C08K 3/36; C08L 9/06

(52) U.S. Cl. 523/351; 524/265

(57) ABSTRACT

The present invention relates to a rubber composition, which can be used for the manufacture of tyres and to a process for the preparation of such a composition. The rubber composition comprises one or more polyhedral oligomeric silsesquioxanes included in the rubber composition as part of a rubber compound masterbatch or added as an additive to a rubber compound masterbatch. The rubber composition of the invention possesses improved hysteresis and physical properties, particularly after vulcanisation.

The present invention relates to a vucanisable rubber composition, which can be used for the manufacture of tyres and to a process for the preparation of such a composition. The rubber composition of the invention possesses improved hysteresis and physical properties, particularly after vulcanisation.

As oil prices have steadily increased and the need to preserve the environment has become an issue of great importance, it has become desirable to produce rubber compositions having improved physical and hysteretic properties. These compositions can be used in the manufacture of various semi-finished products involved in the manufacture of tyres, for example, under layers, sidewalls and treads, and in order to obtain tyres having reduced rolling resistance. Reducing the rolling resistance of tyres lowers the vehicle fuel consumption, which reduces the emission of exhaust gases from the vehicle.

When considering reducing rolling resistance it is also necessary to consider the grip and abrasion properties of the tyre as alteration of one property can impact on the other properties. In reducing rolling resistance, grip and abrasion resistance should not be adversely affected.

To achieve this objective, numerous solutions have been proposed. In particular work has been carried out using a variety of fillers, such as silica and carbon black.

For example, French patent publication No. 2 740 778 discloses the use of diene polymers bearing a silanol function and a polysiloxane block having a silanol end group. These functionalised polymers are intended to be incorporated into vulcanised rubber compositions including silica, as a reinforcing filler, and other fillers comprising a blend of silica and carbon black. These rubber compositions have improved physical and hysteretic properties.

The applicants have surprisingly discovered that a rubber composition can be modified by the addition of a silicon containing nanoscale additive to a rubber compound. The resultant rubber compound can be used to produce tyres with greater traction in wet weather and improved rolling resistance, with little or no effect on abrasion resistance.

Accordingly the present invention provides a rubber composition including one or more polyhedral oligomeric silsesquioxanes.

It is known in the art of rubber manufacture that a rubber composition is made from a) a rubber compound masterbatch, which generally includes one or more rubber polymers and one or more fillers, and b) one or more additives. The rubber composition of the present invention may include the or each polyhedral oligomeric silsesquioxane as part of a rubber compound masterbatch or as an additive to a rubber compound masterbatch.

The present invention further provides a method of producing a rubber composition, which method comprises the steps of: adding one or more polyhedral oligomeric silsesquioxanes to a rubber composition during its manufacture.

The method preferably comprises the production of a rubber compound masterbatch and preferably further comprises the addition of one or more additives to the rubber compound masterbatch.

The or each polyhedral oligomeric silsesquioxane may be included as part of the rubber compound masterbatch. Alternatively the or each polyhedral oligomeric silsesquioxane may be added after production of the rubber compound masterbatch, preferably as an additive to the rubber compound masterbatch. The or each polyhedral oligomeric silsesquioxane may be included as part of the rubber compound masterbatch and as an additive to the rubber compound masterbatch.

Where the polyhedral oligomeric silsesquioxane is added after production of the rubber compound masterbatch it is preferred that the masterbatch has been heated to a temperature of between 80-100° C., more preferably 85° C.

The rubber compound masterbatch may have undergone a silica cross linking reaction, most preferably before addition of the polyhedral oligomeric silsesquioxane.

The rubber polymers of the rubber compound masterbatch typically comprise of a mixture of diene polymers, especially butadiene and styrene butadiene polymers. The rubber polymers can also comprise natural rubber, polyisoprenes or terpolymers, such as styrene butadiene acrylonitrile rubber (SNBR) or styrene butadiene isoprene rubber (SIBR). The rubber polymers may also comprise derivatives of any of the aforementioned polymers.

The masterbatch further comprises one or more fillers, for example one or more silica fillers.

The rubber composition may also comprise any of the usual additives for rubber compositions, for example silane coupling agents and suitable oils.

It will be appreciated that the above method does not exclude the addition of other polymers, additives and the like to the initial masterbatch.

Polyhedral oligomeric silsesquioxanes (POSS) are intermediate compounds between silica (SiO₂) and silicones (R₂SiO) and may be represented by the formula: RSiO_{1.5}, wherein R is selected from alkyl, cyclo alkyl and aryl groups having from 1 to 20 carbon atoms.

Preferably R is selected from cyclohexyl, ethyl, isobutyl, isooctyl, vinyl and phenyl groups. The most preferred polyhedral oligomeric silsesquioxanes are trisilanol isobutyl polyhedral oligomeric silsesquioxane and trisilanol isooctyl polyhedral oligomeric silsesquioxane.

The size of the polyhedral oligomeric silsesquioxanes is preferably from 0.7 to 50 nm and most preferably from 1 to 3 nm.

The or each polyhedral oligomeric silsesquioxane is preferably included in or added to the masterbatch in an amount of 1 to 10 parts per hundred rubber polymer, more preferably 1 to 6 parts per hundred rubber polymer and most preferably 2 to 4 parts per hundred rubber polymer, for example 2 parts per hundred rubber polymer.

The present invention also provides the use of a rubber composition of the present invention, or made by the method of the present invention, in the manufacture of tyres and any component products used in the manufacture of tyres and any products that could be used in conjunction with tyres, particularly to enhance the performance of the tyres.

The invention will now be described, merely by way of example by reference to the following experimental details and the drawings in which:

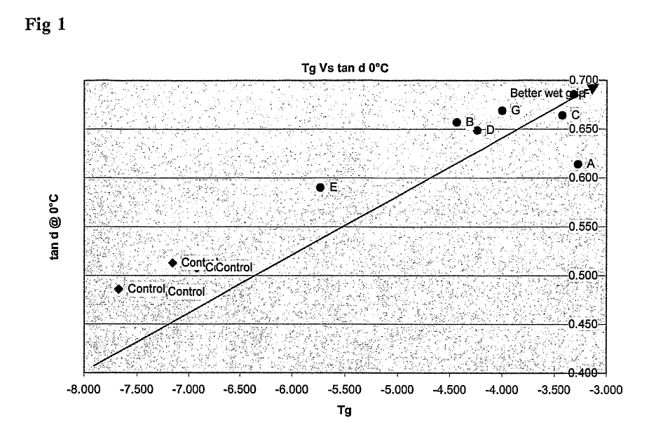

FIG. 1 is a graph of Tg versus Tan δ@ 0° C.;

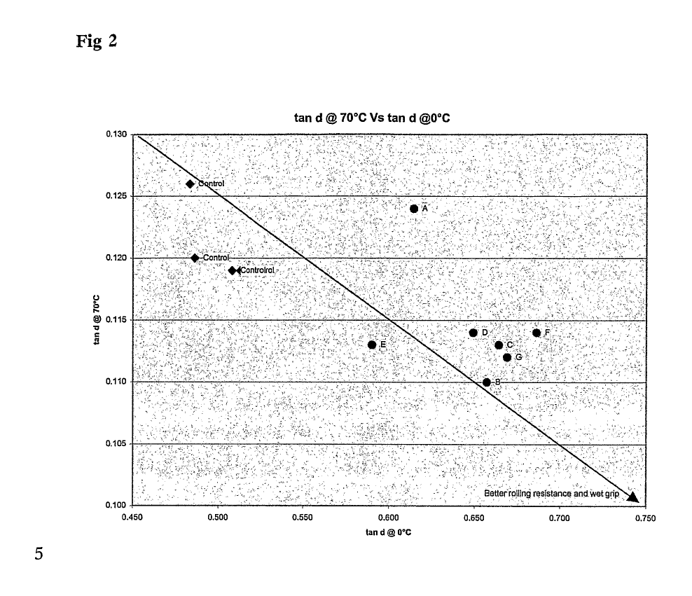

FIG. 2 is a graph of Tan δ@ 0° C. versus Tan δ@ 70° C.; and

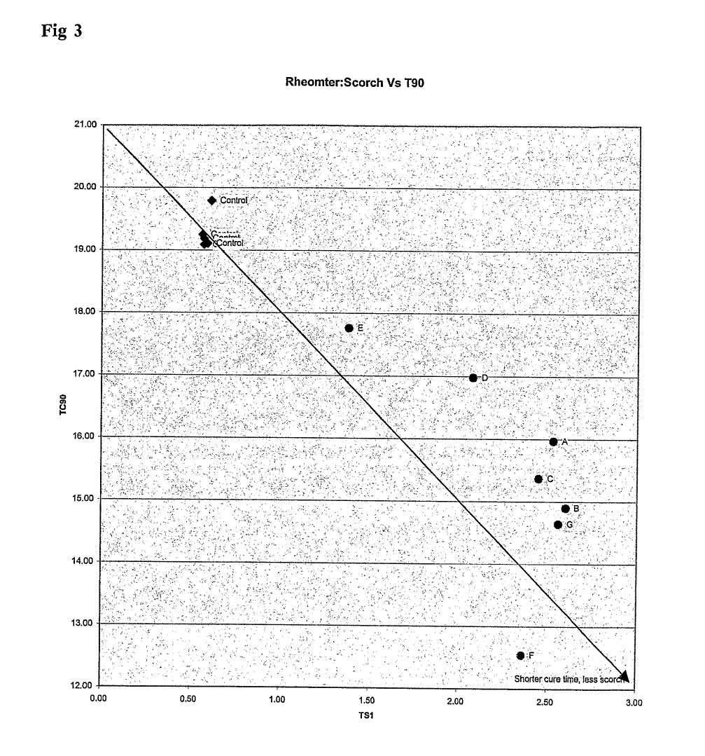

FIG. 3 is a graph of TS1 versus TC90.

TABLE 1
Formulations used
Rubber Compound Masterbatch (first stage mixing):

| | Level | Level | | | | | | |
|---|---|---|---|---|---|---|---|---|
| | (phr) | (phr) | | | | | | |
| Ingredient | Control | A | B | C | D | E | F | G |
| Buna VSL | 110.04 | 110.04 | 110.04 | 110.04 | 110.04 | 110.04 | 110.04 | 110.04 |
| 55525-1 | | | | | | | | |
| Buna | 20.00 | 20.00 | 20.00 | 20.00 | 20.00 | 20.00 | 20.00 | 20.00 |
| CB22 | | | | | | | | |
| Ultrasil | 80.00 | 80.00 | 80.00 | 80.00 | 80.00 | 80.00 | 80.00 | 80.00 |
| VN3 | | | | | | | | |
| Silane | 12.80 | 12.80 | 12.80 | 12.80 | 12.80 | 12.80 | 12.80 | 12.80 |
| X505 | | | | | | | | |
| Aromatic | 5.00 | 5.00 | 5.00 | 5.00 | 5.00 | 5.00 | 5.00 | 5.00 |
| Oil | | | | | | | | |
| (Mobisol | | | | | | | | |
| 30) | | | | | | | | |
| Trisilanol | 0.00 | 3.50 | 0.00 | 0.00 | 0.00 | 0.00 | 0.00 | 0.00 |
| isobutyl | | | | | | | | |
| POSS | | | | | | | | |

Rubber composition ingredients:

| Ingredient | | | | | | | | |
|---|---|---|---|---|---|---|---|---|
| (second | | | | | | | | |
| stage) | Level | | | | | | | |
| Final | (phr) | | | | | | | |
| Composition | Control | A | B | C | D | E | F | G |
| Zinc Oxide | 2.50 | 2.50 | 2.50 | 2.50 | 2.50 | 2.50 | 2.50 | 2.50 |
| Stearic Acid | 1.00 | 1.00 | 1.00 | 1.00 | 1.00 | 1.00 | 1.00 | 1.00 |
| Santoflex 13 | 2.00 | 2.00 | 2.00 | 2.00 | 2.00 | 2.00 | 2.00 | 2.00 |
| Antilux 111 | 1.00 | 1.00 | 1.00 | 1.00 | 1.00 | 1.00 | 1.00 | 1.00 |
| Trisilanol | 0.00 | 0.00 | 3.50 | 3.00 | 2.00 | 1.00 | 3.50 | 3.50 |
| isobutyl | | | | | | | | |
| POSS | | | | | | | | |
| Vinyl POSS | 0.00 | 0.00 | 0.00 | 0.00 | 0.00 | 0.00 | 2.40 | 0.00 |
| Phenyl POSS | 0.00 | 0.00 | 0.00 | 0.00 | 0.00 | 0.00 | 0.00 | 2.40 |
| Ingredient | | | | | | | | |
| (Third | Level | | | | | | | |
| Stage) | (phr) | | | | | | | |
| Sulphur | 1.40 | 1.40 | 1.40 | 1.40 | 1.40 | 1.40 | 1.40 | 1.40 |
| CBS | 1.70 | 1.70 | 1.70 | 1.70 | 1.70 | 1.70 | 1.70 | 1.70 |
| DPG | 2.00 | 2.00 | 2.00 | 2.00 | 2.00 | 2.00 | 2.00 | 2.00 |

Compound A includes the polyhedral oligomeric silsesquioxane in the first stage of the mixing process.

Compounds B-G include the polyhedral oligomeric silsesquioxane in the second stage of the mixing process. In addition compounds B-E each include varying levels of polyhedral oligomeric silsesquioxane and compounds F and G include more than one polyhedral oligomeric silsesquioxane.

These compounds were produced in a three stage process. The first stage of the mixing process produces a rubber compound masterbatch. In the second stage of the process other compounding ingredients are added. In the final stage, curatives are added to produce a final rubber composition.

The First Mixing Stage:

The first stage masterbatches were mixed on a laboratory Banbury type mixer under the following conditions:

| | |
|---|---|
| Banbury temperature | 85° C. |
| Rotor speed | 72 rpm |
| 0 Sec: | Add SBR (styrene butadiene) followed by the |
| | Buna CB22 |
| 60 Sec: | Add ½ silica (Ultrasil VN3) and ½ silane |
| | (X50S) |
| 120 Sec: | Add remaining ½ silica and ½ silane and any |
| | oil and polyhedral oligomeric silsesquioxane |
| | present in the first stage mixing masterbatch |
| | ingredients |
| 180 Sec: | Ram up/down |
| 240 Sec: | Sweep ramp |
| 300 Sec: | Dump |

After mixing the batch temperature was measured using a needle pyrometer. The batch was then placed on a two-roll mill, any loose powder added, and the batch sheeted off. The mill conditions were:

Roll Temperatures:

| | |
|---|---|
| Front: | 20° C. |
| Back: | 20° C. |

Roll Speed:

| | | |
|---|---|---|
| Front: | 13 | rpm |
| Back: | 15 | rpm |
| Nip width set: | 2 | mm |

The batches were weighed after being sheeted off.

The Second Mixing Stage:

The second stage of mixing was performed on a laboratory Banbury type mixer as follows:

| | |
|---|---|
| Banbury | 80° C. |
| temperature: | |
| Rotor speed: | 55 rpm |
| 0 Sec: | Add the relevant masterbatch |
| 60 Sec: | Add polyhedral oligomeric silsesquioxane, if present in |
| | the second stage rubber composition mixing |
| | ingredients, zinc oxide, stearic acid, santoflex 13, wax |
| | (Antilux 111) and silanol, if present. |
| 180 Sec: | Sweep ram |
| 480 Sec: | Dump |

The Third Mixing Stage:

The compound from the second stage was then transferred to an 18″ mill fitted with a scraper blade and the roll temperatures were set at 20° C. for the final mill stage.

The mixed material was bounded on the mill at a nip width of 3 mm.

The sulphur and accelerators (CBS and DPG) were added and dispersed. Once the sulphur and accelerators had been thoroughly dispersed the batch was refined by passing it six times through a tight nip. The completed batch was then sheeted off at a nip width of 3 mm.

A sample of each compound was taken and subjected to cure characteristic measurement at 160° C. in an Alpha Technologies MDR 2000E Rheometer.

Results

1. Effect of Polyhedral Oligomeric Silsesquioxanes on Physical Properties of Rubber Compositions

Tensile Properties

To determine the tensile properties of the rubber compositions the tensile strength and elongation at break were determined in accordance with BS 903: Part A2: Type 1 dumbell.

The crescent tear at room temperature was determined in accordance with BS/ISO 43-1.

Resilience

Dunlop resilience was determined in accordance with BS903: Part A8.

Hampden resilience was determined in accordance with DIN53512, which is equivalent to ISO4662.

Hardness

Hardness was determined in accordance with BS 903: Part A26. All results are in International Rubber Hardness Degrees (IRHD).

Specific Gravity

SG was determined in accordance with BS903: Part A1.

Abrasion Resistance

Akron abrasion was determined in accordance with BS 903: Part A9: Method B, 15° angle.

The results of the above tests on the rubber compositions of the present invention are shown in Tables 2a and 2b.

TABLE 2a
Control Compositions

| | | | | | | Ave |
|---|---|---|---|---|---|---|
| | Control 1 | Control 2 | Control 3 | Control 4 | Control 5 | control |
| Mooney | 107.50 | 111.20 | 113.00 | 116.00 | 113.80 | 112.30 |
| ML1 + 4@100° C. | | | | | | |
| T5 | 22.73 | 20.98 | 20.48 | 20.50 | 19.97 | 20.93 |
| T10 | 27.87 | 25.93 | 25.63 | 25.57 | 25.10 | 26.02 |
| MDR 30′@160° C. | | | | | | |
| ML | 3.97 | 3.83 | 3.95 | 4.02 | 3.96 | 3.95 |
| TS1 | 0.61 | 0.56 | 0.57 | 0.57 | 0.59 | 0.58 |
| TC90 | 19.79 | 19.25 | 19.19 | 19.09 | 19.11 | 19.29 |
| MH | 18.71 | 18.51 | 18.43 | 18.44 | 18.57 | 18.53 |
| MH − ML | 14.74 | 14.68 | 14.48 | 14.42 | 14.61 | 14.59 |
| Hardness (IRHD) | 78.00 | 77.00 | 76.00 | 77.00 | 77.00 | 77.00 |
| SG | 1.212 | 1.211 | 1.209 | 1.210 | 1.209 | 1.210 |
| Tensile Properties | | | | | | |
| Tensile strength (Mpa) | 17.60 | 17.40 | 18.10 | 18.30 | 17.80 | 17.84 |
| Modulus at 100% | 3.00 | 3.17 | 3.19 | 3.06 | 3.10 | 3.10 |
| Modulus at 300% | 12.90 | 14.10 | 14.20 | 13.70 | 13.50 | 13.68 |
| Extension at Break (%) | 365.00 | 351.00 | 359.00 | 378.00 | 373.00 | 365.20 |
| Crescent tear at RT | 43.00 | 41.50 | 37.00 | 38.60 | 38.40 | 39.70 |
| Dunlop resilience at RT | 35.50 | 35.50 | 35.50 | 38.20 | 38.20 | 36.58 |
| Hampden Resilience at | 24.00 | 24.00 | 24.00 | 24.00 | 24.00 | 24.00 |
| RT | | | | | | |
| Akron abrasion loss | 0.110 | 0.115 | 0.103 | 0.140 | 0.106 | 0.115 |
| VES Data | | | | | | |
| Tg | −7.291 | −7.161 | −7.674 | −6.827 | −6.927 | −7.176 |
| tan d @ 70° C. (10 Hz, | 0.126 | 0.119 | 0.120 | 0.119 | 0.119 | 0.121 |
| 0.53%) | | | | | | |
| E′ | 19.00 | 18.20 | 18.20 | 15.40 | 17.10 | 17.58 |
| E″ | 2.60 | 2.30 | 2.30 | 1.90 | 2.20 | 2.26 |
| E* | 19.18 | 18.34 | 18.34 | 15.52 | 17.24 | 17.72 |
| tan d @ 0° C. (10 Hz, | 0.483 | 0.513 | 0.486 | 0.508 | 0.508 | 0.500 |
| 0.56%) | | | | | | |
| E′ | 109.20 | 110.60 | 112.50 | 96.60 | 111.80 | 108.14 |
| E″ | 52.70 | 56.70 | 54.70 | 49.00 | 56.80 | 53.98 |
| E* | 121.25 | 124.29 | 125.09 | 108.32 | 125.40 | 120.87 |

TABLE 2b
Compositions A-G of the present application

| | A | B | C | D | E | F | G |
|---|---|---|---|---|---|---|---|
| Mooney | 75.30 | 83.80 | 85.10 | 90.60 | 101.00 | 79.80 | 81.20 |
| ML1 + 4@100° C. | | | | | | | |
| T5 | | 30.00 | 30.57 | 29.65 | 28.32 | 26.53 | 30.63 |
| MDR 30′@160° C. | | | | | | | |
| ML | 2.04 | 2.17 | 2.19 | 2.46 | 2.85 | 2.10 | 2.17 |
| TS1 | 2.53 | 2.60 | 2.45 | 2.08 | 1.38 | 2.36 | 2.56 |
| TC90 | 15.97 | 14.90 | 15.37 | 16.98 | 17.76 | 12.54 | 14.64 |
| MH | 15.89 | 13.58 | 13.77 | 14.49 | 15.46 | 13.11 | 13.94 |
| MH − ML | 13.85 | 11.41 | 11.58 | 12.03 | 12.61 | 11.01 | 11.77 |
| Hardness (IRHD) | 71.00 | 64.00 | 66.00 | 67.00 | 70.00 | 63.00 | 65.00 |
| SG | 1.207 | 1.211 | 1.209 | 1.208 | 1.209 | 1.207 | 1.209 |
| Tensile properties | | | | | | | |
| TS | 15.20 | 17.50 | 16.30 | 18.50 | 17.70 | 19.00 | 17.60 |
| Modulus at 100% | 2.73 | 2.66 | 2.61 | 2.90 | 2.99 | 2.00 | 2.50 |
| Modulus at 300% | 10.90 | 12.20 | 12.00 | 13.40 | 13.50 | 9.77 | 11.70 |
| Extension at Break | 389.00 | 399.00 | 381.00 | 393.00 | 370.00 | 508.00 | 420.00 |
| Crescent tear at | 45.90 | 45.90 | 46.50 | 55.30 | 41.40 | 57.30 | 43.30 |
| RT | | | | | | | |
| Dunlop resilience | 32.90 | 38.20 | 38.20 | 38.20 | 38.20 | 36.90 | 36.20 |
| at RT | | | | | | | |
| Hampden | 22.00 | 24.00 | 24.00 | 22.00 | 24.00 | 23.00 | 24.00 |
| Resilience at RT | | | | | | | |
| Akron abrasion | 0.113 | 0.112 | 0.124 | 0.092 | 0.104 | 0.071 | 0.164 |
| loss | | | | | | | |
| VES Data | | | | | | | |
| Tg | −3.277 | −4.441 | −3.427 | −4.247 | −5.734 | −3.317 | −4.007 |
| tan d @ 70° C. | 0.124 | 0.110 | 0.113 | 0.114 | 0.113 | 0.114 | 0.112 |
| (10 Hz, 0.53%) | | | | | | | |
| E′ | 14.60 | 10.00 | 10.40 | 11.40 | 12.00 | 9.40 | 10.40 |
| E″ | 2.00 | 1.20 | 1.20 | 1.40 | 1.40 | 1.10 | 1.20 |
| E* | 14.74 | 10.07 | 10.47 | 11.49 | 12.08 | 9.46 | 10.47 |
| tan d @ 0° C. | 0.614 | 0.657 | 0.664 | 0.649 | 0.590 | 0.686 | 0.669 |
| (10 Hz, 0.56%) | | | | | | | |
| E′ | 112.30 | 76.20 | 78.10 | 84.10 | 85.40 | 79.20 | 76.60 |
| E″ | 69.00 | 50.10 | 51.90 | 54.60 | 50.40 | 54.40 | 51.30 |
| E* | 131.80 | 91.19 | 93.77 | 100.27 | 99.16 | 96.08 | 92.19 |

2) Effect of Polyhedral Oligomeric Silsesquioxanes on Viscoelasticity

To determine the viscoelastic properties of the rubber composition a viscoelastic spectrometer (VES) was used. The results are set out in Tables 2a and 2b above.

The results show that polyhedral oligomeric silsesquioxanes, in particular trisilanol isobutyl polyhedral oligomeric silsesquioxane, caused increases in Tg and in Tan δ@0° C. compared to the standard rubber compounds, therefore giving rise to a beneficial effect on wet grip in tyres. The beneficial effects can be seen in a graphical form in FIG. 1.

The results also show that polyhedral oligomeric silsesquioxanes, in particular trisilanol isobutyl polyhedral oligomeric silsesquioxane, caused an increase in Tan δ@0° C. and an approximately level, or slightly lower, measurement in Tan δ@70° C., therefore giving rise to a wet grip benefit with little or no detriment in terms of tyre rolling resistance. The addition of the polyhedral oligomeric silsesquioxanes in the second stage of mixing was seen to give rise to the greatest wet grip benefit with least detriment in terms of tyre rolling resistance. FIG. 2 shows the beneficial effects of the polyhedral oligomeric silsesquioxane on wet grip and rolling resistance.

The polyhedral oligomeric silsesquioxane containing compounds showed a low value for abrasion resistance, with a high Tg value, indicating that these compounds would have the best wet grip, without a deterioration in tyre wear.

Accordingly polyhedral oligomeric silsesquioxanes, in particular trisilanol isobutyl polyhedral oligomeric silsesquioxane showed the ability to modify the viscoelastic properties of an all silica passenger car radial (PCR) tyre tread compound in a way that is advantageous. In particular, the inclusion of this material offers a benefit in terms of wet grip, without having any great deterioration in the other compound properties.

3) Effect of Polyhedral Oligomeric Silsesquioxanes on Cure Characteristics

The cure characteristics for compounds A-G compared to the control compounds are set out in Tables 2a and 2b above and shown in graphical form in FIG. 3.

The addition of the polyhedral oligomeric silsesquioxanes affected the cure characteristics of the rubber compositions A-G by giving rise to a Decrease in T_{C90}, which means that the cure time for the rubber composition is reduced, as it will reach 90% cure in a shorter time. Rubber products made from moulds can be removed from the moulds when cured to 90% so the rubber compositions of the present invention must spend a shorter time in the mould before they can be removed.

4) Effect of the Polyhedral Oligomeric Silsesquioxanes and Additional Filler on Physical Properties.

The results of the study carried out appear to show that the point at which the polyhedral oligomeric silsesquioxane additive is added in the mixing cycle is important to the hardness of the compound obtained. Experimentation has shown that if the additive is added in the second mixing stage, a greater hardness is observed than when the additive is added in the first stage.

Compounds A-G would appear to exhibit comparable resilience and abrasion loss properties.

Accordingly the results show that polyhedral oligomeric silsesquioxanes, in particular trisilanol isobutyl polyhedral oligomeric silsesquioxane have the ability to modify the viscoelastic properties of an all silica passenger car radial (PCR) tyre tread compound in a way that is advantageous. In particular, the inclusion of this material offers a benefit in terms of wet grip, without having any great deterioration in the other compound properties. Furthermore the cure characteristics of the rubber composition are also improved by the addition of the polyhedral oligomeric silsesquioxane.

1. A rubber composition comprising one or more polyhedral oligomeric silsesquioxanes.

2. A rubber composition according to claim 1 wherein the or each polyhedral oligomeric silsesquioxane is included in the rubber composition as part of a rubber compound masterbatch.

3. A rubber composition according to claim 1 wherein the or each polyhedral oligomeric silsesquioxane is added as an additive to a rubber compound masterbatch.

4. A rubber composition according to claim 2 wherein the rubber compound masterbatch comprises one or more diene polymers, or derivatives or a mixture thereof.

5. A rubber composition according to claim 4 wherein the diene polymers are selected from butadiene, styrene butadiene and derivatives, or mixtures, thereof.

6. A rubber composition according to claim 1 wherein the rubber composition masterbatch comprises natural rubber, a polyisoprene or a terpolymer, or derivatives or mixtures thereof.

7. A rubber composition according to claim 6 wherein the terpolymer is styrene butadiene acrylonitrile rubber (SNBR) or styrene butadiene isoprene rubber (SIBR), or mixtures or derivatives thereof.

8. A rubber composition according to claim 1 wherein the masterbatch further comprises one or more of any usual additives for rubber compositions.

9. A rubber composition according to claim 1 wherein the or each polyhedral oligomeric silsesquioxane is represented by the formula:
RSiO_{1.5}
wherein R is selected from alkyl, cycloalkyl and aryl groups having from 1 to 20 carbon atoms.

10. A rubber composition according to claim 9 wherein R is selected from cyclohexyl, ethyl, isobutyl, isooctyl, vinyl and phenyl groups.

11. A rubber composition according to claim 10 wherein the or each polyhedral oligomeric silsesquioxane is selected from trisilanol isobutyl polyhedral oligomeric silsesquioxane and trisilanol isooctyl polyhedral oligomeric silsesquioxane.

12. A rubber composition according to claim 1 in which the or each polyhedral oligomeric silsesquioxane is present in the masterbatch in an amount of 1 to 10 parts per hundred rubber polymer.

13. A rubber composition according to claim 12 in which the or each polyhedral oligomeric silsesquioxane is present in the masterbatch in an amount of 2 to 6 parts per hundred rubber polymer.

14. A rubber composition according to claim 12 in which the or each polyhedral oligomeric silsesquioxane is present in the masterbatch in an amount of 2 parts per hundred rubber polymer.

15. A method of producing a rubber composition, which method comprises the step of adding one or more polyhedral oligomeric silsesquioxanes to a rubber composition during its manufacture.

16. A method according to claim 15 wherein the method comprises the production of a rubber compound masterbatch and the addition of one or more additives to the masterbatch.

17. A method according to claim 16 wherein the or each polyhedral oligomeric silsesquioxane is included as part of the rubber compound masterbatch.

18. A method according to claim 16 wherein the or each polyhedral oligomeric silsesquioxane is added as an additive to the rubber compound masterbatch.

19. A method according to claim 16 in which the or each polyhedral oligomeric silsesquioxane is added to the masterbatch to give a total amount of 1 to 10 parts per hundred rubber polymer.

20. A method according to claim 19 in which the or each polyhedral oligomeric silsesquioxane is added to the masterbatch to give a total amount of 2 to 6 parts per hundred rubber polymer.

21. A method according to claim 19 in which the or each polyhedral oligomeric silsesquioxane is added to the masterbatch to give a total amount of 2 parts per hundred rubber polymer.

22. A method according to claim 16 wherein the rubber compound masterbatch or the rubber composition is subjected to vulcanisation.

23. Use of a rubber composition of claim 1 in the manufacture of tyres and any component products used in the manufacture of tyres and any products that could be used in conjunction with tyres, particularly to enhance the performance of the tyres.

24. (canceled)

25. (canceled)

26. (canceled)
